(19) United States
(12) Patent Application Publication
(10) Pub. No.: US 2005/0057218 A1
(43) Pub. Date: Mar. 17, 2005

(54) Charger

(76) Inventor: Chia-Shang Chen, Fong San City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/796,524

(22) Filed: Mar. 8, 2004

(30) Foreign Application Priority Data
Sep. 15, 2003 (CN) 03279642.0

(51) Int. Cl. H02J 7/00

(52) U.S. Cl. 320/115

(57) ABSTRACT

A charger has a main body, a cell chamber disposed in the main body, an electric power source plug disposed on a bottom of the main body, a cigarette ignition plug disposed on a rear portion of the main body, an upper cover, a connector, and a rear cover. The electric power source plug is used as an alternating current power source terminal. The cigarette ignition plug is used as a direct current power source terminal. A cell disposed in the cell chamber is used as a cell power source terminal. The main body has a charging electric circuit connected to the alternating current power source terminal, the direct current power source terminal, and the cell power source terminal. The upper cover is disposed on an upper portion of the main body to cover the cell chamber. The connector is connected to the main body and the rear cover. The rear cover covers the cigarette ignition plug.

### FIELD OF THE INVENTION

The present invention relates to a charger, and more particularly to a charger which is connected to one of three electric power sources.

### BACKGROUND OF THE INVENTION

A conventional charger is used for charging cells of a portable electronic device such as a portable telephone, a notebook computer, or a personal digital assistant (PDA). However, the conventional charger should be connected to a converter plug which is connected to a socket disposed in a room. If an automobile has a cigarette ignition plug, the converter plug will be replaced by the cigarette ignition plug. When a user is not in a room nor in an automobile, the conventional charger cannot charge cells of the portable electronic device.

### SUMMARY OF THE INVENTION

An object of the present invention is to provide a charger which has an alternating current power source terminal connected to an alternating current power source.

Another object of the present invention is to provide a charger which has a direct current power source terminal connected to a direct current power source.

Another object of the present invention is to provide a charger which has a cell power source terminal connected to a cell power source.

Accordingly, a charger comprises a main body and a cell chamber disposed in the main body. The main body has a charging electric circuit connected to an alternating current power source terminal, a direct current power source terminal, and a cell power source terminal.

### BRIEF DESCRIPTION OF THE DRAWINGS

FIG. 1 is a front elevational view of a charger of a preferred embodiment in accordance with the present invention;

FIG. 2 is a top plan view of a charger of a preferred embodiment in accordance with the present invention;

FIG. 3 is a bottom plan view of a charger of a preferred embodiment in accordance with the present invention;

FIG. 4 is a front elevational view of a charger of a preferred embodiment while an upper cover is removed and a rear cover is opened;

FIG. 5 is a top plan view of a charger of a preferred embodiment while an upper cover and a rear cover are removed;

FIG. 6 is a bottom plan view of a charger of a preferred embodiment while an upper cover and a rear cover are removed;

FIG. 7 is a perspective exploded view of a charger of a preferred embodiment in accordance with the present invention;

FIG. 8A is a perspective view of an upper cover of a preferred embodiment in accordance with the present invention;

FIG. 8B is another perspective view of an upper cover of a preferred embodiment in accordance with the present invention;

FIG. 9 is a perspective view of a connector of a preferred embodiment in accordance with the present invention;

FIG. 10A is a top plan view of an upper cover of a preferred embodiment in accordance with the present invention;

FIG. 10B is a bottom plan view of an upper cover of a preferred embodiment in accordance with the present invention;

FIG. 10C is a sectional view taken along line 100-100 in FIG. 10A;

FIG. 11 is a schematic flow chart of a charging electric circuit; and

FIG. 12 is a schematic diagram of a charging electric circuit.

### DETAILED DESCRIPTION OF THE INVENTION

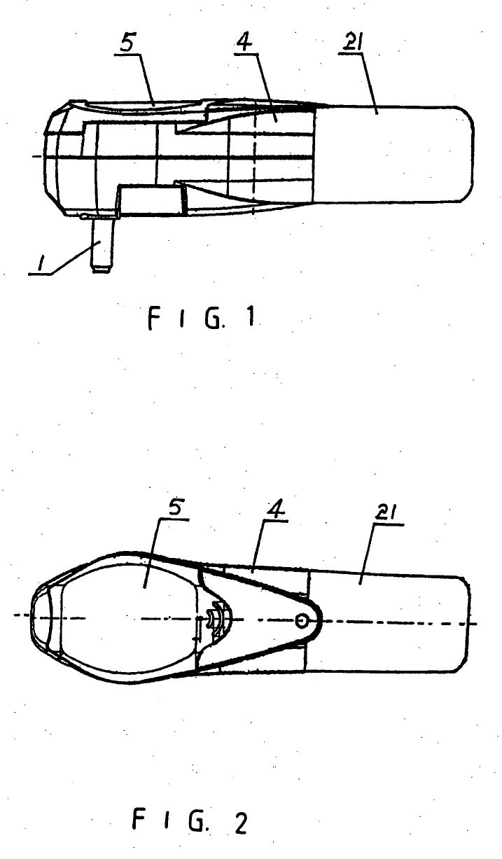

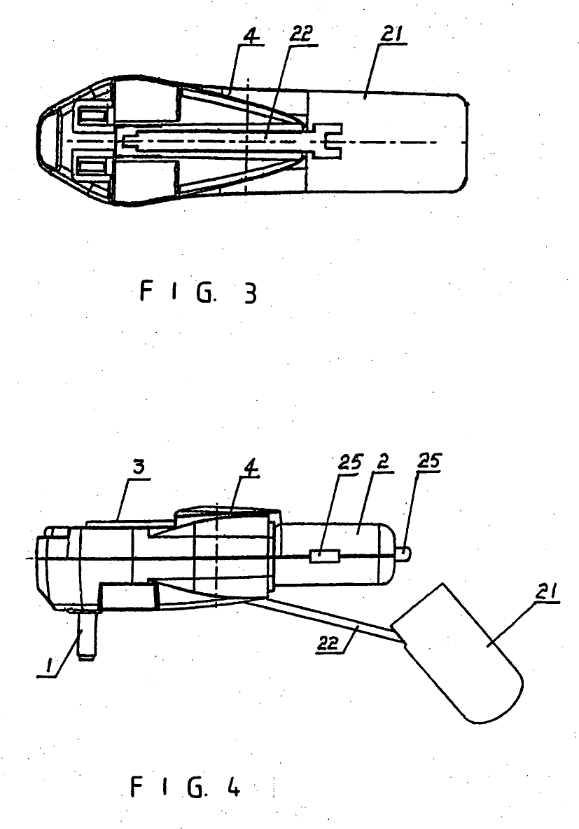

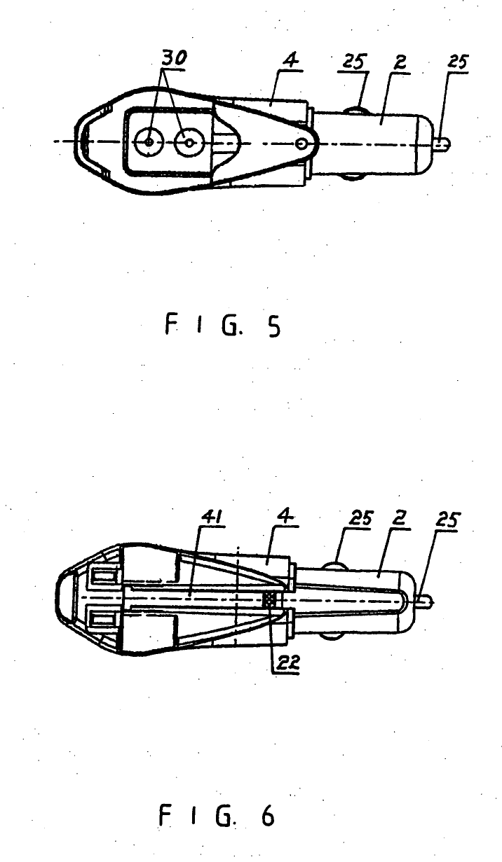

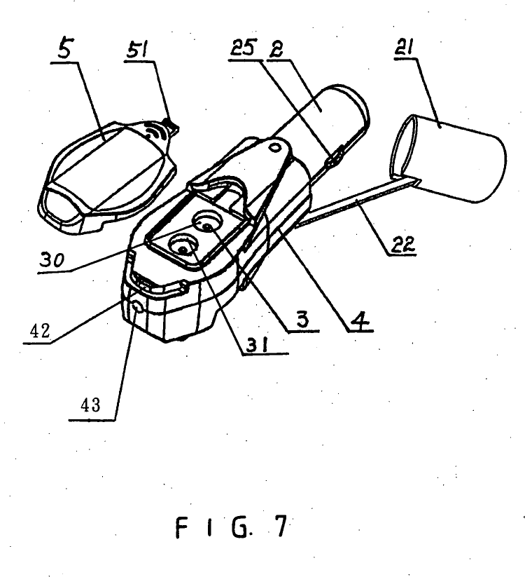

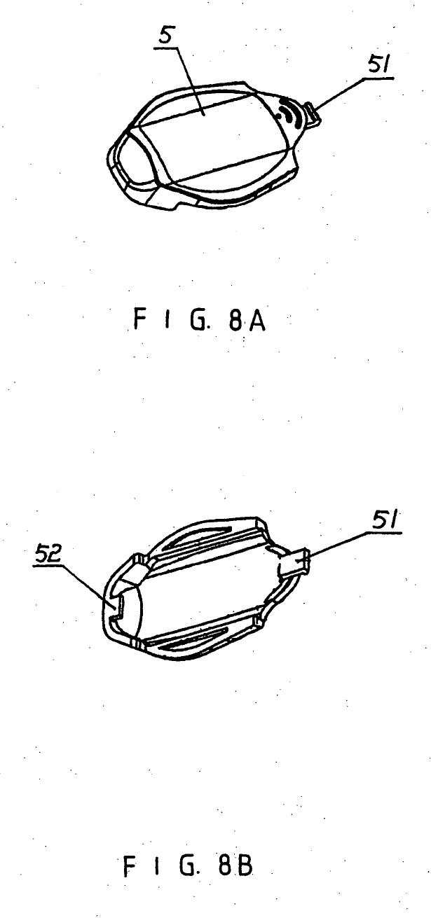

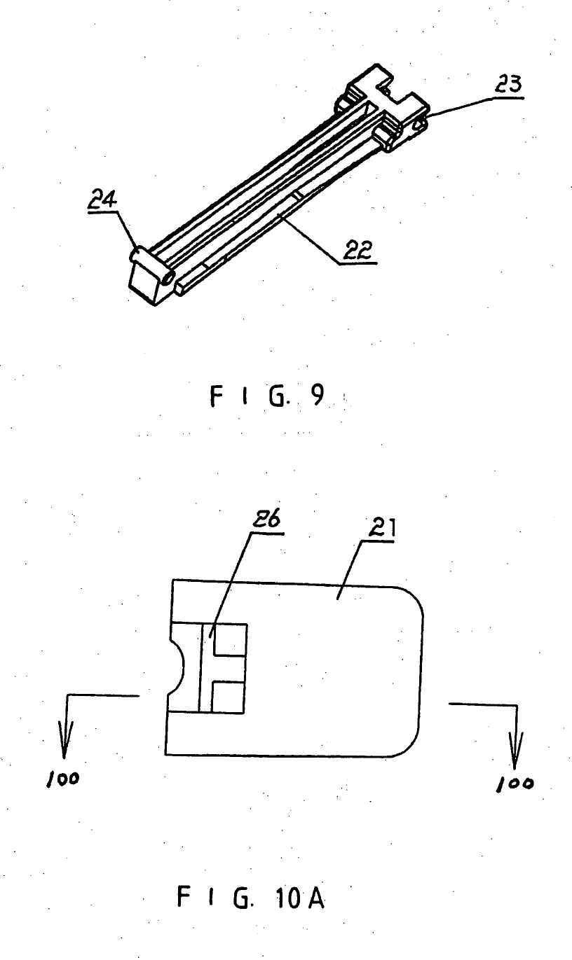

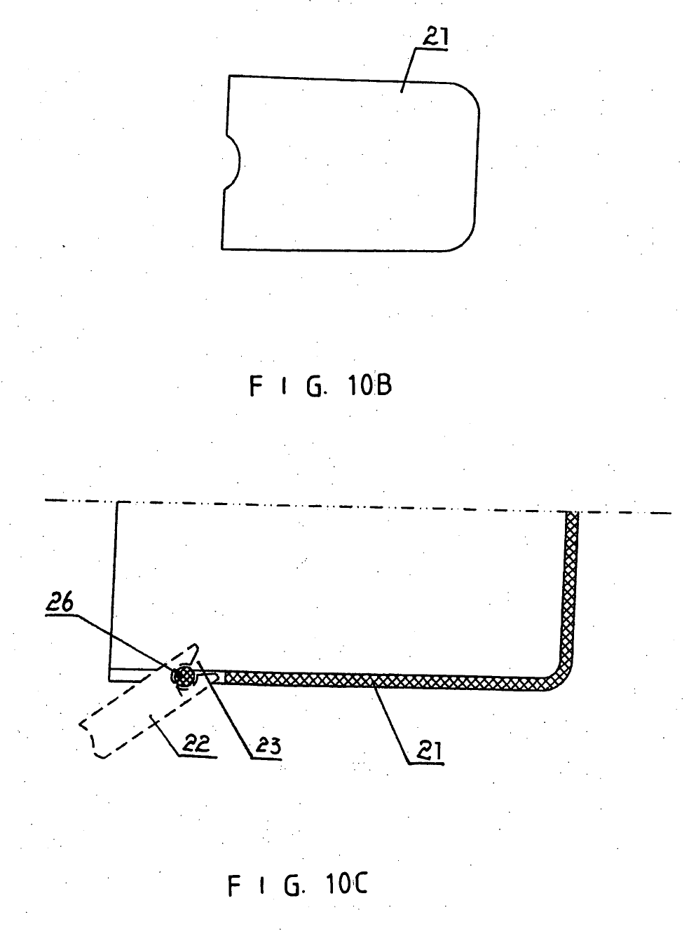

Referring to FIGS. 1 to 10C, a charger comprises a main body 4 and a cell chamber 3 disposed in the main body 4.

The main body 4 has a charging electric circuit connected to an alternating current power source terminal A1, a direct current power source terminal A2, and a cell power source terminal A3.

An electric power source plug 1 disposed on a bottom of the main body 4 is used as the alternating current power source terminal A1. It is an option that the electric power source plug 1 has two blades.

A cigarette ignition plug 2 disposed on a rear portion of the main body 4 is used as the direct current power source terminal A2. The cigarette ignition plug 2 has a plurality of electrodes 25. The cigarette ignition plug 2 matches a cigarette ignition socket of an automobile (not shown in the figures).

A cell 30 disposed in the cell chamber 3 is used as the cell power source terminal A3.

An upper cover 5 is disposed on an upper portion of the main body 4 to cover the cell chamber 3. The upper cover 5 has a distal click hook 52 and an end click block 51.

A connector 22 is connected to the main body 4 and the rear cover 21. The connector 22 has a distal shaft 24 and an end notch 23.

A rear cover 21 covers the cigarette ignition plug 2. The rear cover 21 has a click fastener device 26 engaging with the end notch 23 of the connector 22.

The main body 4 further has a front groove 42 to engage with the distal click hook 52, a front hole 43 to receive a wire (not shown in the figures), and a slide channel 41 to engage with the distal shaft 24.

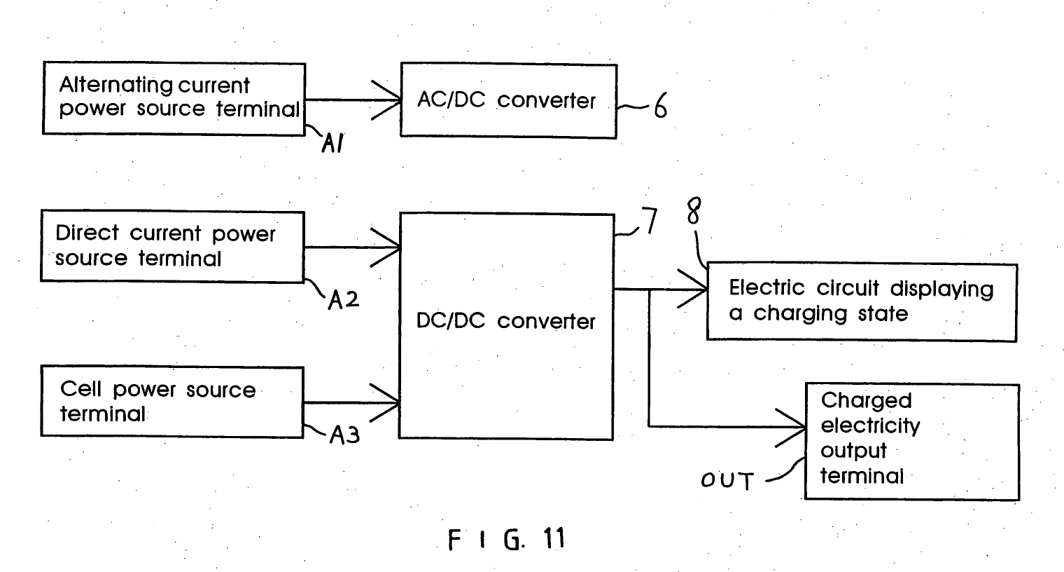

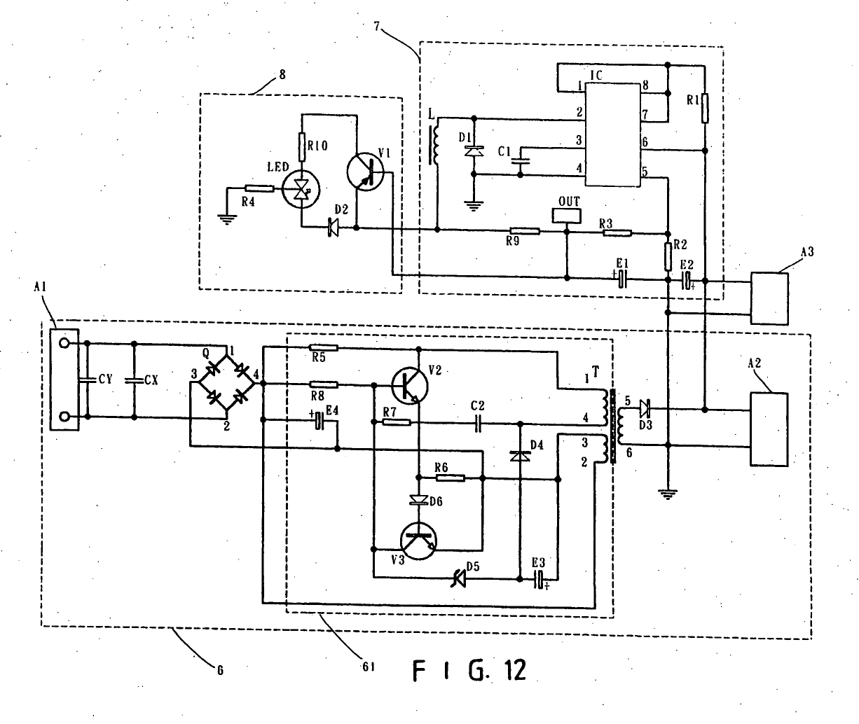

Referring to FIGS. 11 and 12, the charging electric circuit has an AC/DC converter 6, a DC/DC converter 7, and an electric circuit 8 displaying a charging state.

An input terminal of the AC/DC converter 6 is connected to the alternating current power source terminal A1.

An output terminal of the AC/DC converter 6 is connected to an input terminal of the DC/DC converter 7.

The input terminal of the DC/DC converter 7 is connected to the direct current power source terminal A2 and the cell power source terminal A3.

The output terminal of the DC/DC converter 7 is connected to an input terminal of the electric circuit 8 displaying a charging state.

The AC/DC converter 6 has a rectifier Q, an oscillator 61, a drop-away voltage transformer T, and an output rectifier diode D3.

An input terminal of the rectifier Q is connected to an alternating current power source terminal A1.

An output terminal of the rectifier Q is connected to an input terminal of the oscillator 61. The oscillator 61 is connected to an input terminal of the DC/DC converter 7 through the drop-away voltage transformer T and the output rectifier diode D3.

The oscillator 61 has the drop-away voltage transformer T and two triodes V2 and V3.

An alternating current flows from the alternating current power source terminal A1 to two capacitors CX and CY, the rectifier Q, the input terminal of the oscillator 61, the drop-away voltage transformer T, the output rectifier diode D3, and the input terminal of the DC/DC converter 7.

The DC/DC converter 7 has an integrated circuit IC, an inductor L, a diode D1, an output resistor R9, a first filter capacitor E1 and a second filter capacitor E2.

The integrated circuit IC has a first pin, a second pin, a third pin, a fourth pin, a fifth pin, a sixth pin, a seventh pin, and an eighth pin.

The sixth pin is connected to the direct current power source terminal A2 and the second filter capacitor E2.

The second pin is connected to the inductor L and the diode D1.

The inductor L is connected to the output resistor R9.

A is connected to the output resistor R9 and the first filter capacitor E1.

The DC/DC converter 7 will produce an output voltage of approximately 5 volts.

The electric circuit 8 displaying a charging state has a triode V1, a twin light emitting diode LED, a diode D2, and a current-limiting resistor R4.

A base of the triode V1 is connected to the charging electricity output terminal OUT. An emitter of the triode V1 is connected to the diode D2 and the output resistor R9.

A collector of the triode V1 is connected to the twin light emitting diode LED.

The twin light emitting diode LED is connected to the diode D2 and the current-limiting resistor R4.

When the charger is charged, an electric current will flow through the output resistor R9. The output resistor R9 will produce a potential difference to initiate the triode V1. An output voltage of the DC/DC converter 7 will be added to the twin light emitting diode LED to enlighten the twin light emitting diode LED.

The present invention is not limited to the above embodiment but various modification thereof may be made. Furthermore, various changes in form and detail may be made without departing from the scope of the present invention.

1. A charger comprising:
a main body and a cell chamber disposed in the main body,
the main body having a charging electric circuit connected to an alternating current power source terminal, a direct current power source terminal, and a cell power source terminal.

2. The charger as claimed in claim 1, wherein an electric power source plug disposed on a bottom of the main body is used as the alternating current power source terminal.

3. The charger as claimed in claim 1, wherein a cigarette ignition plug disposed on a rear portion of the main body is used as the direct current power source terminal.

4. The charger as claimed in claim 3, wherein the cigarette ignition plug has a plurality of electrodes, a connector is connected to the main body and a rear cover, and the rear cover covers the cigarette ignition plug.

5. The charger as claimed in claim 1, wherein a cell disposed in the cell chamber is used as the cell power source terminal.

6. The charger as claimed in claim 5, wherein an upper cover is disposed on an upper portion of the main body to cover the cell chamber.

7. The charger as claimed in claim 1, wherein the charging electric circuit has an AC/DC converter, a DC/DC converter and an electric circuit displaying a charging state, an input terminal of the AC/DC converter is connected to the alternating current power source terminal, an output terminal of the AC/DC converter is connected to an input terminal of the DC/DC converter, the input terminal of the DC/DC converter is connected to the direct current power source terminal and the cell power source terminal, and the output terminal of the DC/DC converter is connected to an input terminal of the electric circuit displaying a charging state.

8. The charger as claimed in claim 7, wherein the AC/DC converter has a rectifier, an oscillator, a drop-away voltage transformer and an output rectifier diode, an input terminal of the rectifier is connected to an alternating current power source terminal, an output terminal of the rectifier is connected to an input terminal of the oscillator, and the oscillator is connected to an input terminal of the DC/DC converter through the drop-away voltage transformer and the output rectifier diode.

9. The charger as claimed in claim 7, wherein the DC/DC converter 7 has an integrated circuit IC, an inductor L, a diode D1, an output resistor R9, a first filter capacitor E1 and a second filter capacitor E2, the integrated circuit IC has a fist pin, a second pin, a third pin, a fourth pin, a fifth pin, a sixth pin, a seventh pin and an eighth pin, the sixth pin is connected to the direct current power source terminal and the second filter capacitor, the second pin is connected to the inductor and the diode, the inductor is connected to the output resistor, and a charging electricity output terminal is connected to the output resistor and the first filter capacitor.

10. The charger as claimed in claim 7, wherein the electric circuit displaying a charging state has a triode, a twin light emitting diode, a diode and a current-limiting resistor, a base of the triode is connected to the charging electricity output terminal, an emitter of the triode is connected to the diode and the output resistor, a collector of the triode is connected to the twin light emitting diode, and the twin light emitting diode is connected to the diode and the current-limiting resistor.
